(19) United States
(12) Patent Application Publication
(10) Pub. No.: US 2018/0182393 A1
(43) Pub. Date: Jun. 28, 2018

(54) SECURITY ENHANCED SPEECH RECOGNITION METHOD AND DEVICE

(71) Applicant: SAMSUNG ELECTRONICS CO., LTD., Suwon-si (KR)

(72) Inventors: Woo-chul SHIM, Yongin-si (KR); Il-Joo KIM, Seoul (KR)

(73) Assignee: SAMSUNG ELECTRONICS CO., LTD., Suwon-si (KR)

(21) Appl. No.: 15/852,705

(22) Filed: Dec. 22, 2017

(30) Foreign Application Priority Data
Dec. 23, 2016 (KR) 10-2016-0177941

(51) Int. Cl. G10L 15/22; G10L 17/00

(52) U.S. Cl. CPC G10L 15/22; G10L 2015/227; G10L 2015/223; G10L 17/005

(57) ABSTRACT

A security-enhanced speech recognition method and electronic device are provided. The electronic device according includes an input device configured to receive a speech signal, and a processor configured to perform speech recognition, wherein the processor determines whether to perform speech recognition based on whether the input device has been activated.

### CROSS-REFERENCE TO RELATED APPLICATION

This application claims the priority from Korean Patent Application No. 10-2016-0177941, filed on Dec. 23, 2016 in the Korean Intellectual Property Office, the disclosure of which is incorporated herein in its entirety by reference.

### BACKGROUND

### 1. Field

Example embodiments of the present disclosure relate to security-enhanced speech recognition, and more particularly, to a speech recognition method and device capable of enhancing security by authenticating a speech signal before performing speech recognition, and performing speech recognition on an authenticated speech signal.

### 2. Description of the Related Art

In general, speech recognition is a technology for automatically converting speech received from a user to text by recognizing the speech. Recently, as interface technology for replacing keyboard inputs in smart phones, televisions (TVs), etc., speech recognition is used. In particular, an interface for speech recognition in a vehicle or at home is being provided, and environments in which speech recognition can be used are increasing. For example, a user can use a speech recognition system to execute various functions, such as playing music, ordering goods, connecting to a website, etc.

However, if a speech signal received from a user without proper authority with respect to an electronic device is created as a command through a speech recognition system, a security problem may arise. The user without proper authority with respect to the electronic device may damage, falsify, forge, or leak information stored in the electronic device through the speech recognition system.

### SUMMARY

One or more example embodiments provide a speech recognition method and apparatus for authenticating a speech signal, and performing speech recognition on an authenticated speech signal.

One or more example embodiments also provide a non-transitory computer-readable recording medium storing a program for executing the method on a computer.

According to an aspect of an example embodiment, there is provided an electronic device including an input device configured to receive a speech signal, and a processor configured to perform speech recognition, wherein the processor is further configured to determine whether to perform speech recognition, based on whether the input device has been activated.

The processor may be further configured to not perform speech recognition on a speech signal transmitted directly to the processor and not through the input device.

The input device may include a microphone, and the processor may be further configured to determine whether the microphone has been operated, and perform speech recognition in response to determining that the microphone has been operated.

The processor may be further configured to determine whether a user having proper authority with respect to the electronic device is located within a predetermined distance from the electronic device, and in response to determining that the user is located within the predetermined distance from the electronic device, perform speech recognition.

The processor may be configured to determine whether the user is located within the predetermined distance from the electronic device based on information corresponding to one or more devices that the user uses.

The information about the one or more devices that the user uses may include at least one from among position information, network connection information, and login recording information of the one or more devices that the user uses.

According to an aspect of another example embodiment, there is provided a speech recognition method performed by an electronic device, the speech recognition method including determining whether an input device in the electronic device for receiving a speech signal has been activated; and performing speech recognition, in response to determining that the input device has been activated.

The speech recognition method may further include not performing speech recognition on a speech signal transmitted directly to the electronic device and not through the input device.

The determining whether the input device has been activated may include determining whether a microphone for receiving the speech signal has been operated, and wherein the performing the speech recognition may include performing speech recognition in response to determining that the microphone has been operated.

The speech recognition method further include determining whether a user having proper authority with respect to the electronic device is located within a predetermined distance from the electronic device, in response to determining that the input device has been activated, wherein the performing the speech recognition may include performing speech recognition in response to determining that the user is located within the predetermined distance from the electronic device.

The determining whether the user having the proper authority for the electronic device is located within the predetermined distance from the electronic device may include determining whether the user is located within the predetermined distance from the electronic device based on information corresponding to one or more devices that the user uses.

The information about the one or more devices that the user uses may include at least one from among position information, network connection information, and login recording information of the one or more devices that the user uses.

A non-transitory computer-readable recording medium storing a program may execute the speech recognition method.

### BRIEF DESCRIPTION OF THE DRAWINGS

The above and/or other aspects will become apparent and more readily appreciated from the following description of example embodiments, taken in conjunction with the accompanying drawings in which:

FIG. 1 shows an environment in which an electronic device according to an example embodiment performs speech recognition;

FIG. 2 is a block diagram of an electronic device according to an example embodiment;

FIG. 3 is a block diagram of an electronic device according to an example embodiment;

FIG. 4 shows a predetermined condition for authenticating a speech signal according to an example embodiment;

FIG. 5 is a flowchart of a speech recognition method according to example an embodiment; and

FIG. 6 is a flowchart of a speech recognition method according to example an embodiment.

### DETAILED DESCRIPTION

Hereinafter, example embodiments of the present disclosure will be described in detail with reference to the accompanying drawings. These example embodiments are described in sufficient detail to enable those skilled in the art to practice the present disclosure, and it is to be understood that the example embodiments are not intended to limit the present disclosure to particular modes of practice, and it is to be appreciated that all modification, equivalents, and alternatives that do not depart from the spirit and technical scope of the present disclosure are encompassed in the present disclosure.

Throughout the specification, it will be understood that when a part “includes” or “comprises” an element, unless otherwise defined, the part may further include other elements, not excluding the other elements. It will be further understood that the singular forms “a,” “an,” and “the” include plural referents unless the context clearly dictates otherwise.

Expressions such as “at least one of” or “at least one from among” when preceding a list of elements, modify the entire list of elements and do not modify the individual elements of the list. For example, the expression, “at least one from among a, b, and c,” should be understood as including only a, only b, only c, both a and b, both a and c, both b and c, or all of a, b, and c.

Also, the term “portion” or “module” used in the present specification may mean a hardware component or circuit such as a Field Programmable Gate Array (FPGA) or an Application Specific Integrated Circuit (ASIC).

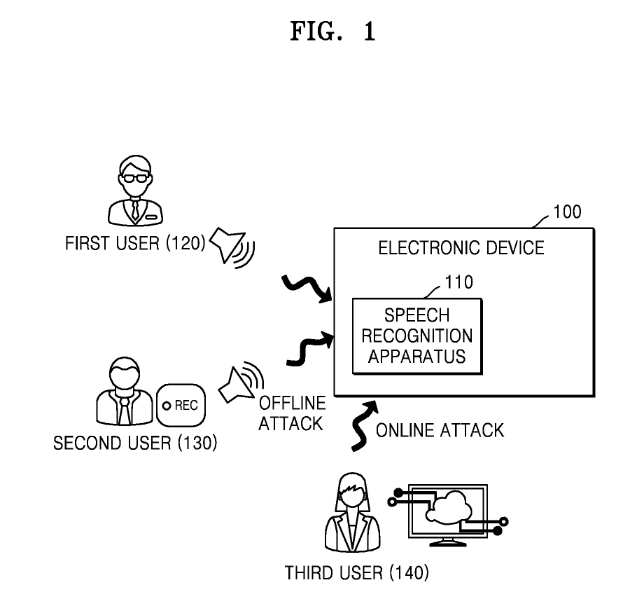

FIG. 1 shows an environment in which an electronic device according to an example embodiment performs speech recognition.

In an electronic device 100, a speech recognition function for generating a command from a received speech signal may be installed. The electronic device 100 according to an example embodiment may be any one of a home appliance (for example, a television (TV), a washing machine, a refrigerator, a lamp, a cleaner, etc.), a portable terminal (for example, a phone, a smart phone, a tablet, an electronic book, a watch such as a smart watch, glasses such as smart glasses, vehicle navigation system, vehicle audio system, vehicle video system, vehicle integrated media system, telematics, a notebook, etc.), a TV, a personal computer (PC), an intelligent robot, and a speaker, etc. however, example embodiments are not limited thereto.

For example, if the electronic device 100 is a speaker located at home or an office and having a speech recognition function, a user may issue a command for playing music to the electronic device 100, or may inquire the electronic device 100 about a pre-registered schedule. Also, the user may inquire the electronic device 100 about weather or a sports schedule, or may issue a command to read an electronic book.

According to an example embodiment, a speech recognition apparatus 110 may be installed in the electronic device 100 to perform the speech recognition function of the electronic device 100. For example, if the electronic device 100 is a speaker, the speech recognition apparatus 110 may be a hardware component installed in the speaker to perform speech recognition. In FIG. 1, the electronic device 100 is shown to include the speech recognition apparatus 110, however, in the following description, the electronic device 100 may be the speech recognition apparatus 110 for convenience of description. Accordingly, a user inputting a speech signal to the electronic device 100 may include inputting a speech signal to the speech recognition apparatus 110 in the electronic device 100. Also, a user being located around the electronic device 100 may include a user being located within a predetermined distance from the speech recognition apparatus 110.

The electronic device 100 may receive a speech signal. For example, the user may make a speech signal (or speech data), in order to transfer a speech command that is to be subject to speech recognition. The speech signal may include a speech signal made directly toward the electronic device 100, a speech signal transmitted from another device, a server, etc. through a network, a speech file received through storage medium, etc., and the other party's speech signal transmitted through, for example, a phone call. For example, the user may output a speech signal through another device connected to the electronic device 100 through Bluetooth, and the speech signal output may be transferred to the electronic device 100 through a network.

The electronic device 100 may create a command for performing a specific operation from the received speech signal. A command according to an example embodiment may include control commands for executing various operations, such as playing music, ordering goods, connecting to a website, controlling an electronic device, etc. Also, the electronic device 100 may perform additional operations based on the result of speech recognition. For example, the electronic device 100 may provide the result of an Internet search based on a speech-recognized word, transmit a message of speech-recognized content, perform schedule management such as inputting a speech-recognized appointment, or play audio/video corresponding to a speech-recognized title.

The electronic device 100 according to an example embodiment may perform speech recognition on the received speech signal based on an acoustic model and a language model. The acoustic model may be created through a statistical method by collecting a large amount of speech signals. The language model may be a grammatical model for a user's speech, and may be acquired through statistical learning by collecting a large amount of text data.

In order to ensure the performances of the acoustic model and the language model, a large amount of data may need to be gathered, and data collected from unspecified individuals' speech may be used to configure a speaker-independent model. In contrast, data collected from a specific user may be used to configure a speaker-dependent model. If sufficient data can be gathered, the speaker-dependent model may have higher performance of speech recognition than the speaker-independent model. The electronic device 100 according to an example embodiment may perform speech recognition on a received speech signal based on the speaker-independent model or the speaker-dependent model.

For example, a first user 120 may be a user having a proper authority for the electronic device 100. For example, the first user 120 may be a user of a smart phone in which the electronic device 100 is installed. The first user 120 may be a person whose account has been registered in the electronic device 100. A proper user of the electronic device 100 may be a plurality of persons. The first user 120 may input a speech signal to the electronic device 100, and the electronic device 100 may perform speech recognition on the received speech signal.

A second user 130 may be a user without proper authority for the electronic device 100, although the second user 130 is located around the electronic device 100. For example, the second user 130 may be a third party intruder who attempts to damage, falsify, forge, or leak information stored in the electronic device 100 without proper authority. When the second user 130 inputs his/her speech signal to the electronic device 100, the electronic device 100 may perform one of two operations as follows.

If the electronic device 100 performs speech recognition based on the speaker-independent model, the electronic device 100 may not determine whether or not a speech signal received from the second user 130 is a speech signal received from a user having proper authority.

If the electronic device 100 performs speech recognition based on the speaker-dependent model, the electronic device 100 may determine that the second user 130 is a user without proper authority, and may not perform speech recognition on the received speech signal. For example, since the electronic device 100 may configure a model by gathering speech signals made from the first user 120, the electronic device 100 may determine that the speech signal received from the second user 130 is not a valid speech signal capable of creating a command.

However, if the second user 130 records a speech signal of the first user 120 and reproduces it or the second user 130 acquires a speech sample of the first user 120, and reconstructs a speech signal based on the sample, and reproduces it, even when the electronic device 100 performs speech recognition based on the speaker-dependent model, the electronic device 100 may determine that the received speech signal is a speech signal received from the first user 120 with proper authority. A third party intruder located around the electronic device 100 making his/her speech signal or reproducing another user's speech signal to create a command is referred to as an “offline attack”. Also, the speech signal received from the second user 130 is referred to as an offline attack speech signal.

A third user 140 may also be a user without proper authority for the electronic device 100. The third user 140 may also be a third party intruder who attempts to damage, falsify, forge, or leak information stored in the electronic device 100 without proper authority. However, the third user 140 may be different from the second user 130 in that the third user 140 is located at a further distance from the electronic device 100 than the second user 130, and may directly access a speech recognition algorithm in the electronic device 100 to cause the electronic device 100 to perform speech recognition. The speech recognition algorithm according to an example embodiment may be an Application Programming Interface (API) for speech recognition.

Since the third user 140 may directly access the speech recognition algorithm in the electronic device 100 to cause the electronic device 100 to perform speech recognition, the third user 140 may neither need to make a speech signal toward the electronic device 100 nor need to reproduce a speech signal toward the electronic device 100. When a third party intruder located at a further distance from the electronic device 100 transmits a speech signal to the electronic device 100, the transmitted speech signal may directly access the speech recognition algorithm in the electronic device 100 to create a command referred to as an “online attack”. Also, the speech signal transmitted from the third user 140 to the electronic device 100 is referred to as an online attack speech signal.

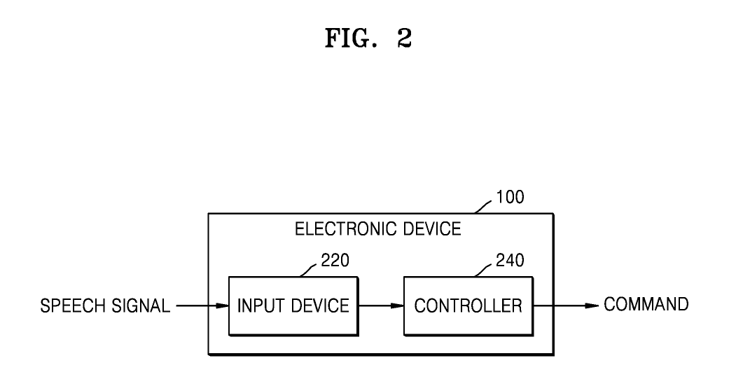

FIG. 2 is a block diagram of an electronic device according to an example embodiment.

The electronic device 100 may include an input device 220 and a controller 240.

The input device 220 may receive a speech signal. The input device 220 according to an example embodiment may be a microphone. For example, the input device 220 may receive a user's speech signal through a microphone. The input device 220 according to an example embodiment may receive, instead of receiving a speech signal made from a user, a speech signal transmitted from another device, a server, etc. through a network, a speech file received through storage medium, etc., or the other party's speech transmitted through, for example, a phone call.

The controller 240 may determine whether to perform speech recognition, based on whether the input device 220 has been activated. The controller 240 according to an example embodiment may be an Application Specific Integrated Circuit (ASIC), an embedded processor, a microprocessor, hardware control logic, a hardware Finite-State Machine (FSM), a digital signal processor (DSP), or a combination thereof. According to an example embodiment, the controller 240 may include at least one processor.

The controller 240 according to an example embodiment may not perform speech recognition on a speech signal transmitted directly to the controller 240, and not through the input device 220. The controller 240 according to example an embodiment may determine whether the input device 220 for receiving a speech signal subject to speech recognition has been activated, prior to performing speech recognition, in order to determine whether to perform speech recognition. In the case of an online attack, the speech recognition algorithm in the controller 240 may be operated directly by a third party intruder, and not through the input device 220. Therefore, if a speech signal requesting speech recognition is received when the input device 220 has not been activated, the controller 240 may determine the speech signal requesting speech recognition as an online attack speech signal transmitted directly to the controller 240 not through the input device 220, and may not perform speech recognition on the online attack speech signal.

The controller 240 according to an example embodiment may determine whether, for example, a microphone for receiving a speech signal has operated. Also, if the input device 220 receives a speech signal from another device, a server, etc. through a network, the controller 240 may determine whether the input device 220 has been activated in order to receive the speech signal. When the input device 220 according to an example embodiment uses a speech signal transferred from another device as an input speech signal, the controller 240 may determine whether a microphone of the other device that received a speech signal directly from a user and transferred the speech signal to the input device 220 has operated. When the controller 240 determines that the microphone has operated, the controller 240 may perform speech recognition.

The controller 240 according to an example embodiment may determine whether a user having a proper authority is located around the electronic device 100. If no user having a proper authority is located around the electronic device 100, there is higher probability that a speech signal requesting speech recognition is an invalid signal intruded by an offline attack or an online attack.

A user being located around the electronic device 100 according to an example embodiment may be a user being located in a region within a predetermined distance from the electronic device 100, or a virtual area connected to the electronic device 100 through a network. The virtual area may be a virtual area in which a plurality of devices including the electronic device 100 are located. For example, the virtual area may be a wireless local area network (WLAN) service area using the same wireless router, such as home, an office, a library, a café, etc.

The controller 240 according to an example embodiment may perform speech recognition when determining that a user having a proper authority is located around the electronic device 100. The controller 240 may use information about one or more devices that the user uses, in order to determine whether the user having the proper authority is located around the electronic device 100. The one or more devices that the user uses may be one or more devices that are different from the electronic device 100. For example, if the electronic device 100 is a speaker, the one or more devices that the user uses may include a smart phone, a tablet PC, and a TV.

The controller 240 according to an example embodiment may determine whether a user having a proper authority is located around the electronic device 100, based on position information of the one or more devices that the user uses. For example, the controller 240 may determine whether a mobile device or a wearable device being used by a user having a proper authority is located around the electronic device 100, based on Global Positioning System (GPS) or Global System for Mobile communication (GMS) information of the mobile device or the wearable device that the user uses. The controller 240 according to an example embodiment may use media access control (MAC) address information of one or more devices that a user having a proper authority uses, in order to acquire position information of the user.

The controller 240 according to an example embodiment may determine whether a user having a proper authority is located around electronic device 100, based on network connection information of one or more devices that the user uses. For example, if the controller 240 finds the user's device connected to the electronic device 100 through Bluetooth, the controller 240 may determine that the user having the proper authority is located around the electronic device 100. For example, if the electronic device 100 is a mobile device, such as a smart phone or a table PC, and a wearable device wirelessly connected to the electronic device 100, such as glasses, a watch, or a band type device, exists, the controller 240 may determine that the user having the proper authority is located around the electronic device 100. For example, the controller 110 may use information about whether one or more devices that the user uses are connected to a specific access point (AP) or located in a specific hotspot.

The controller 110 according to an example embodiment may determine whether a user having a proper authority is located around the electronic device 100, based on login information of one or more devices that the user uses. For example, the controller 240 may check whether a user having a proper authority has been logged in a TV it controls, and if the controller 240 determines that the user is in a login state, the controller 240 may determine that a user having a proper authority is located around the electronic device 100.

Information about one or more devices that the user uses, according to an example embodiment, may include user log information detected in an Internet of Things (IoT) environment. For example, the controller 240 of the electronic device 100 located at home may perform speech recognition after checking information informing that a user has entered home through a front door with a sensor by a method of using a digital key or inputting a fingerprint. For example, the controller 240 of the electronic device 100 fixed at home may perform speech recognition after determining that a user's vehicle exists in a garage.

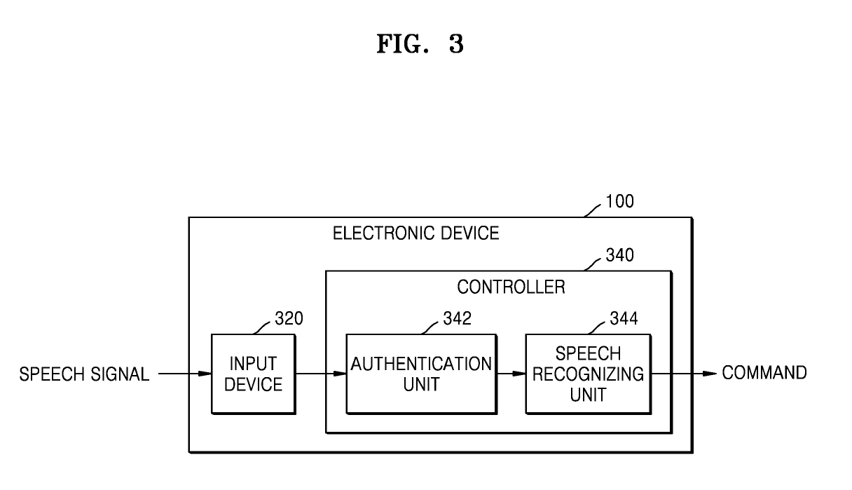

FIG. 3 is a block diagram of an electronic device according to an example embodiment.

An electronic device 100 of FIG. 3 shows an example embodiment of the electronic device 100 of FIG. 2. Accordingly, the above description about the electronic device 100 of FIG. 2 can be applied to the electronic device 100 of FIG. 3.

According to an example embodiment, the electronic device 100 may include an input device 320 and a controller 340. The input device 320 and the controller 340 may respectively correspond to the input device 220 and the controller 240 of FIG. 2.

The controller 340 may perform speech recognition on a speech signal. The controller 340 according to an example embodiment may include an authentication unit 342 and a speech recognizing unit 344.

The authentication unit 342 may authenticate a speech signal before speech recognition is performed.

The authentication unit 342 may determine whether the input device 320 has been activated, in order to receive a speech signal to be subject to speech recognition. The authentication unit 342 may determine whether a microphone has operated, and if a speech signal requesting speech recognition is received when the microphone has not operated, the authentication unit 342 may not transfer the speech signal to the speech recognizing unit 344. Also, when the input device 320 receives a speech signal from another device, a server, etc. through a network, the authentication unit 342 may determine whether the input device 320 for receiving a speech signal has been activated.

The authentication unit 342 according to an example embodiment may determine whether a user having a proper authority is located around the electronic device 100. The authentication unit 342 according to an example embodiment may determine whether a user having a proper authority is located around the electronic device 100, based on information about one or more devices that the user uses. The information about the one or more devices that the user uses, according to an example embodiment, may include at least one from among position information such as GPS or GMS information, information about access to a specific AP, network connection information such as Bluetooth connection information, user login information, and user log information detected in an IoT environment of the one or more devices that the user uses.

If the authentication unit 342 determines that the input device 320 has not been activated or that no user having a proper authority is located around the electronic device 100, the authentication unit 342 may not transfer the speech signal to the speech recognizing unit 344.

The speech recognizing unit 344 may perform speech recognition on a speech signal authenticated by the authentication unit 342. The speech recognizing unit 344 according to an example embodiment may include APIs for performing a speech recognition algorithm.

The speech recognizing unit 344 according to an example embodiment may perform pre-processing on the speech signal. The pre-processing may include a process of extracting data required for speech recognition, that is, a signal available for speech recognition. The signal available for speech recognition may be, for example, a signal from which noise has been removed. Also, the signal available for speech recognition may be an analog/digital converted signal, a filtered signal, etc.

The speech recognizing unit 344 may extract a feature for the pre-processed speech signal. The speech recognizing unit 344 may perform model-based prediction using the extracted feature. For example, the speech recognizing unit 344 may compare the extracted feature to speech model database to thereby calculate a feature vector. The speech recognizing unit 344 may perform speech recognition based on the calculated feature vector, and perform pre-processing on the result of the speech recognition.

However, example embodiments are not limited thereto, and the speech recognizing unit 344 may use various speech recognition algorithm for performing speech recognition.

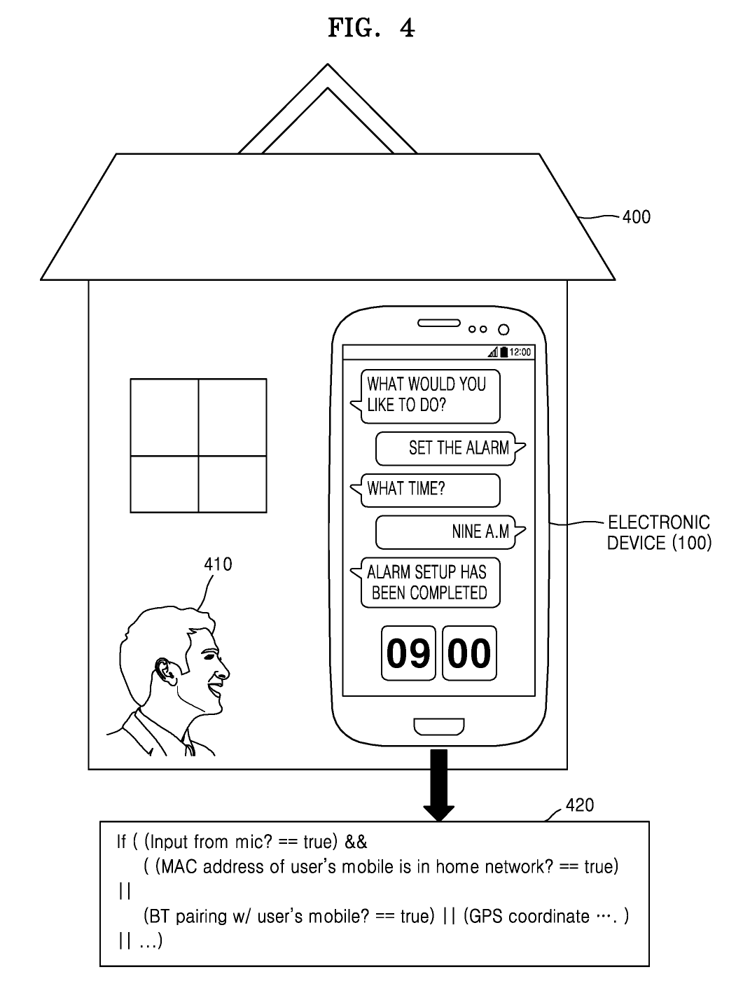

FIG. 4 shows a predetermined condition for authenticating a speech signal according to an example embodiment.

A user 410 located at home may make a speech signal toward the electronic device 100, and the electronic device 100 may receive the speech signal to perform speech recognition.

The electronic device 100 may determine whether a predetermined condition for performing speech recognition is satisfied, prior to performing speech recognition. The electronic device 100 according to an example embodiment may use a conditional statement 420 in order to determine whether the predetermined condition is satisfied. The electronic device 100 according to an example embodiment may determine whether the speech signal has been received through a microphone, using the conditional statement 420. Also, if the electronic device 100 according to an example embodiment determines that the speech signal has been received through the microphone, the electronic device 100 may determine whether the user 410 is located at home, using at least one of MAC address information, Bluetooth connection information, and GPS information of the user's device.

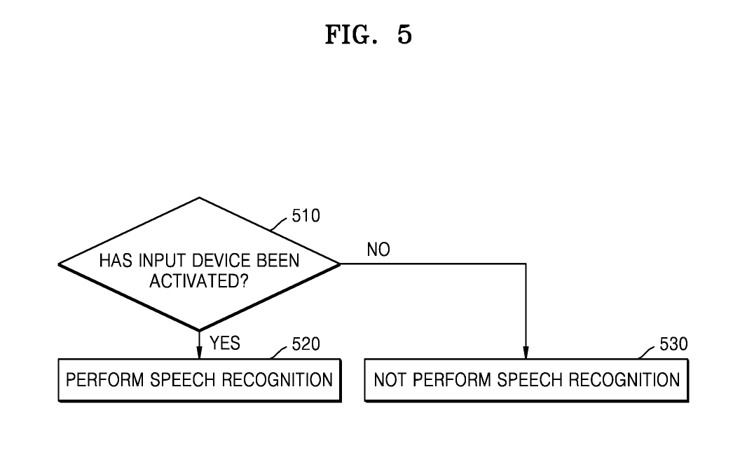

FIG. 5 is a flowchart of a speech recognition method according to example an embodiment.

In operation 510, the electronic device 100 may determine whether an input device in the electronic device 100 has been activated. The input device according to an example embodiment may be a hardware component or circuit that can receive a speech signal. The input device according to an example embodiment may include a microphone to receive a user's speech signal. Also, the input device according to an example embodiment may include a communication circuit to receive speech transmitted from another device, a server, etc. through a network, a speech file transferred through storage medium, etc., and the other party's speech transmitted through a phone call. In the case of an online attack, since a third party intruder's speech signal may directly access a speech recognition algorithm and not through the input device, the electronic device 100 according to an example embodiment may not perform speech recognition if the input device has not been activated although a speech signal requesting speech recognition is received. If the electronic device 100 determines that the input device has been activated, the electronic device 100 may perform speech recognition, in operation 520. If the electronic device 100 determines that the input device has not been activated, the electronic device 100 may not perform speech recognition, in operation 530.

In operation 520, the electronic device 100 may perform speech recognition. The electronic device 100 according to an example embodiment may perform speech recognition using various speech recognition algorithms to create a command. For example, the electronic device 100 may perform pre-processing on a speech signal, and extract a feature for the pre-processed speech signal. The electronic device 100 may perform model-based prediction using the extracted feature. For example, the electronic device 100 may compare the extracted feature to speech model database to thereby calculate a feature vector. The electronic device 100 may perform speech recognition based on the calculated feature vector to create a command.

In operation 530, the electronic device 100 may not perform speech recognition on a speech signal transmitted directly to the electronic device 100 and not through the input device. Since the input device has not been activated although a speech signal requesting speech recognition has been received, the electronic device 100 may determine the speech signal requesting speech recognition as an online attack speech signal transmitted directly to the electronic device 100 not through the input device, and may not perform speech recognition.

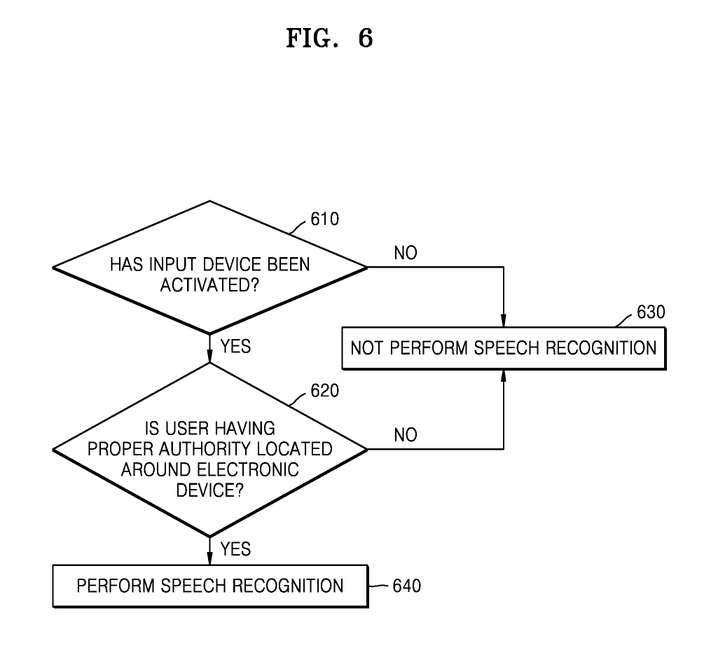

FIG. 6 is a flowchart of a speech recognition method according to an example embodiment.

Operation 610, operation 630, and operation 640 may respectively correspond to operation 510, operation 530, and operation 520 of FIG. 5.

In operation 610, the electronic device 100 may determine whether an input device in the electronic device 100 has been activated. If the electronic device 100 determines that the input device has been activated, the electronic device 100 may perform additional authentication in order to determine whether to perform speech recognition, in operation 620. If the electronic device 100 determines that the input device has not been activated, the electronic device 100 may not perform speech recognition, in operation 630.

In operation 620, the electronic device 100 may determine whether a user having a proper authority is located around the electronic device 100. The electronic device 100 may determine whether a user having a proper authority is located around the electronic device 100, and if the electronic device 100 determines that a user having a proper authority is located around the electronic device 100, the electronic device 100 may perform speech recognition. The electronic device 100 according to an example embodiment may use information about one or more devices that the user uses, in order to determine whether the user having the proper authority is located around the electronic device 100. The information about the one or more devices that the user uses, according to an example embodiment, may include at least one among position information such as GPS or GMS information, information about access to a specific AP, network connection information such as Bluetooth connection information, user login information, and user log information detected in an IoT environment of the one or more devices that the user uses. If the electronic device 100 determines that no user having a proper authority exists around the electronic device 100, the electronic device 100 may not perform speech recognition, in operation 630.

In operation 620, if the electronic device 100 determines that a user having a proper authority is located around the electronic device 100, the electronic device 100 may perform speech recognition, in operation 640.

Meanwhile, the speech recognition method as described above may be implemented as a computer-readable code in a non-transitory computer-readable recording medium. The computer-readable recording medium includes all types of recording medium storing data that can be read by computer system. Examples of the computer-readable recording medium include read-only memory(ROM), random access memory (RAM), compact disk read only memory (CD-ROM), magnetic tapes, floppy disks, and optical data storage devices. Also, the computer-readable recording medium can be implemented in the form of transmission through the Internet. In addition, the computer-readable recording medium may be distributed to computer systems over a network, in which processor-readable codes may be stored and executed in a distributed manner.

While example embodiments have been described with reference to the drawings, it will be understood by those of ordinary skill in the art that various changes in form and details may be made therein without departing from the spirit and scope as defined by the following claims and their equivalents.

What is claimed is:

1. An electronic device comprising:
an input device configured to receive a speech signal; and
a processor configured to perform speech recognition,
wherein the processor is further configured to determine whether to perform speech recognition, based on whether the input device has been activated.

2. The electronic device of claim 1, wherein the processor is further configured to not perform speech recognition on a speech signal transmitted directly to the processor and not through the input device.

3. The electronic device according to claim 1, wherein the input device comprises a microphone, and
the processor is further configured to determine whether the microphone has been operated, and perform speech recognition in response to determining that the microphone has been operated.

4. The electronic device according to claim 1, wherein the processor is further configured to:
determine whether a user having proper authority with respect to the electronic device is located within a predetermined distance from the electronic device, and
in response to determining that the user is located within the predetermined distance from the electronic device, perform speech recognition.

5. The electronic device according to claim 4, wherein the processor is configured to determine whether the user is located within the predetermined distance from the electronic device based on information corresponding to one or more devices that the user uses.

6. The electronic device according to claim 5, wherein the information about the one or more devices that the user uses comprises at least one from among position information, network connection information, and login recording information of the one or more devices that the user uses.

7. A speech recognition method performed by an electronic device, the speech recognition method comprising:
determining whether an input device in the electronic device for receiving a speech signal has been activated; and
performing speech recognition, in response to determining that the input device has been activated.

8. The speech recognition method of claim 7, further comprising not performing speech recognition on a speech signal transmitted directly to the electronic device and not through the input device.

9. The speech recognition method of claim 7, wherein the determining whether the input device has been activated comprises determining whether a microphone for receiving the speech signal has been operated, and
wherein the performing the speech recognition comprises performing speech recognition in response to determining that the microphone has been operated.

10. The speech recognition method of claim 7, further comprising determining whether a user having proper authority with respect to the electronic device is located within a predetermined distance from the electronic device, in response to determining that the input device has been activated,
wherein the performing the speech recognition comprises performing speech recognition in response to determining that the user is located within the predetermined distance from the electronic device.

11. The speech recognition method of claim 10, wherein the determining whether the user having the proper authority for the electronic device is located within the predetermined distance from the electronic device comprises determining whether the user is located within the predetermined distance from the electronic device based on information corresponding to one or more devices that the user uses.

12. The speech recognition method of claim 11, wherein the information about the one or more devices that the user uses comprises at least one from among position information, network connection information, and login recording information of the one or more devices that the user uses.

13. A non-transitory computer-readable recording medium storing a program for executing the method of claim 7 on a computer.
